(19) United States
(12) Patent Application Publication
(10) Pub. No.: US 2015/0065116 A1
(43) Pub. Date: Mar. 5, 2015

(54) REMOTE CONTROL DEVICE AND WIRELESS COMMUNICATION SYSTEM COMPRISING THE SAME

(71) Applicant: SUNREX TECHNOLOGY CORP., Taichung City (TW)

(72) Inventors: Chien-Hung Chen, Taichung City (TW); Hsing-Kuang Chen, Taichung City (TW)

(73) Assignee: SUNREX TECHNOLOGY CORP., Taichung City (TW)

(21) Appl. No.: 14/012,966

(22) Filed: Aug. 28, 2013

(51) Int. Cl. H04W 8/22

(52) U.S. Cl. CPC H04W 8/22
USPC 455/419

(57) ABSTRACT

A remote control device is adapted for communicating with and controlling a portable wireless communication device, and includes a communication module for communicating with the portable wireless communication device, a detecting module for detecting movement of an object, and a control unit electrically coupled to the detecting module and the communication module. The control unit is operable to transmit through the communication module a control signal to the portable wireless communication device so as to control operation of the portable wireless communication device when it is determined that the movement of the object is in a predetermined direction.

### BACKGROUND OF THE INVENTION

1. Field of the Invention

The invention relates to a remote control device, more particularly to a remote control device for controlling a portable wireless communication device. The invention also relates to a wireless communication system comprising the remote control device.

2. Description of the Related Art

A conventional Bluetooth device for a vehicle is usually disposed proximate to a driver seat, and is operable to connect with a user's cellular phone via the Bluetooth protocol. The user is able to control operation of the cellular phone, such as answering an incoming telephone call or terminating a telephone call, by operating the conventional Bluetooth device. Accordingly, the user does not need to hold the cellular phone with one hand while driving, thereby lowering the risk of accidents.

Since an input platform of the conventional Bluetooth device is usually composed of buttons or a touch panel which needs to be pushed or to be touched in order to control the cellular phone, attention of the user still might be distracted when operating the conventional Bluetooth device. Therefore, there is a need in the art to provide a remote control device that may minimize user distraction while driving the vehicle.

### SUMMARY OF THE INVENTION

Therefore, the object of the present invention is to provide a remote control device that is easy to operate and that may alleviate the aforementioned drawback of the prior art.

According to one aspect of the present invention, a remote control device is adapted for communicating with and controlling a portable wireless communication device, and comprises a communication module for wirelessly communicating with the portable wireless communication device, a detecting module for detecting movement of an object within a predetermined space, and a control unit electrically coupled to the detecting module and the communication module. The control unit is operable to determine whether the object moves in a predetermined direction according to detection result from the detecting module, and to transmit through the communication module a control signal to the portable wireless communication device so as to control operation of the portable wireless communication device when it is determined that the movement of the object detected by the detecting module is in the predetermined direction.

According to another aspect of the present invention, a wireless communication system comprises a portable wireless communication device and a remote control device. The remote control includes a communication module for wirelessly communicating with the portable wireless communication device, a detecting module for detecting a movement direction of an object within a predetermined space, and a control unit electrically coupled to the detecting module and the communication module. The control unit is operable to determine whether the object moves in a predetermined direction according to detection result from the detecting module, and to transmit through the communication module a control signal to the portable wireless communication device to control operation of the portable wireless communication device when it is determined that the movement of the objected detected by the detecting module is in the predetermined direction.

### BRIEF DESCRIPTION OF THE DRAWING

Other features and advantages of the present invention will become apparent in the following detailed description of the preferred embodiment with reference to the accompanying drawing, of which:

FIG. 1 is a schematic diagram of a preferred embodiment of a wireless communication system according to the invention.

### DETAILED DESCRIPTION OF THE PREFERRED EMBODIMENT

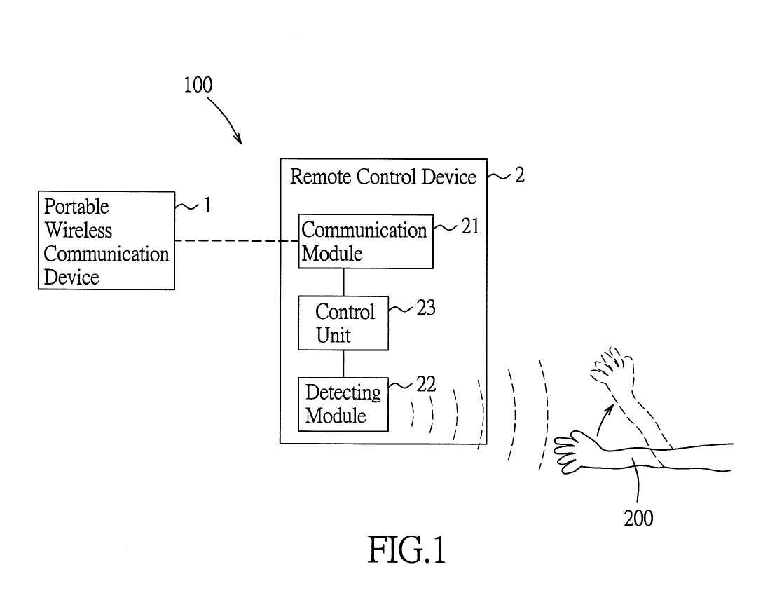

Referring to FIG. 1, the preferred embodiment of a wireless communication system 100 of this invention is shown to include a portable wireless communication device 1 and a remote control device 2. In this embodiment, the portable wireless communication device 1 is a cellular phone. For example, in the case that the wireless communication system 100 is used in a vehicle, the remote control device 2 is disposed proximate to a driver seat of the vehicle. It should be noted that the wireless communication system 100 is not limited for use in a vehicle, and can be used in other occasions and situations.

The remote control device 2 includes a communication module 21, a detecting module 22, and a control unit 23.

The communication module 21 is operable to wirelessly communicate with the portable wireless communication device 1. In this embodiment, the communication module 21 is a Bluetooth module, and the portable wireless communication device 1 includes a Bluetooth module that is capable of communicating with the communication module 21 via the Bluetooth protocol. However, communication between the portable wireless communication device 1 and the communication module 21 is not limited to the disclosure of this embodiment.

The detecting module 22 is configured to detect movement of an object 200 within a predetermined space. In this embodiment, the detecting module 22 is, but should not be limited to, an infrared detecting module. That is, the detecting module 22 is operable to transmit infrared signals, receiving infrared signals reflected from the object 200, and determining a movement direction of the object 200 based on the received infrared signals. In this embodiment, the object 200 is a user's hand. That is, when the user's hand is moving in the predetermined space, the detecting module 22 is capable of determining the movement direction of the user's hand.

The control unit 23 is electrically coupled to the detecting module 22 and the communication module 21, and is operable to determine whether the object moves in a predetermined direction according to detection result from the detecting module 22. When it is determined that the movement of the object 200 detected by the detecting module 22 is in the predetermined direction, the control unit 23 is further operable to transmit through the communication module 21 a control signal to the portable wireless communication device 1 so as to control operation of the portable wireless communication device 1. In this embodiment, the predetermined direction is a bottom-top direction, which means the control unit 23 is capable of determining if the user's hand is moving in the bottom-top direction according to the movement direction of the object 200 detected by the detecting module 22. In this embodiment, the control unit 23 is operable to transmit the control signal to control the portable wireless communication device 1 (i.e., the cellular phone) to answer an incoming telephone call and/or to terminate a telephone call. Therefore, the user only needs to put his/her hand into the predetermined space and move in the bottom-top direction when the incoming telephone call needs to be answered. Similarly, the user only needs to put his/her hand into the predetermined space and move in the bottom-top direction to terminate the telephone call.

In practice, the control unit 23 may be further operable to determine if the object 200 moves in one of four predetermined directions according to the movement direction detected by the detecting module 22. In this case, the four predetermined directions are bottom-top, top-bottom, left-right, right-left directions. Besides, the control unit 23 is capable of transmitting one of four different control signals, which correspond respectively to the four predetermined directions, through the communication module 21 to control the portable wireless communication device 1 to execute a corresponding operation. For example, the control signals corresponding to the four predetermined directions may cause the portable wireless communication device 1 to execute four different operations, respectively, such as to answer an incoming telephone call, to terminate a telephone call, to play music, and to stop playing music.

To sum up, the detecting module 22 of the remote control device 2 according to the present invention works as an input platform that allows the user to easily operate the portable wireless communication device 1 by moving his/her hand in the predetermined space while driving the vehicle, thereby minimizing user distraction and lowering the risk of accidents.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A remote control device adapted for communicating with and controlling a portable wireless communication device, said remote control device comprising:
a communication module operable to wirelessly communicate with the portable wireless communication device;
a detecting module configured to detect movement of an object within a predetermined space; and
a control unit electrically coupled to said detecting module and said communication module, and operable to determine whether the object moves in a predetermined direction according to detection result from said detecting module, and to transmit through said communication module a control signal to the portable wireless communication device so as to control operation of the portable wireless communication device when it is determined that the movement of the object detected by said detecting module is in the predetermined direction.

2. The remote control device as claimed in claim 1, the portable wireless communication device being a cellular phone, wherein said control unit is operable to transmit the control signal to control the portable wireless communication device to answer an incoming telephone call or to terminate a telephone call.

3. The remote control device as claimed in claim 1, wherein said detecting module is an infrared detecting module.

4. The remote control device as claimed in claim 1, wherein said communication module is a Bluetooth module.

5. The remote control device as claimed in claim 1, wherein, when it is determined that the movement of the object detected by said detecting module is in one of predetermined directions, said control unit is operable to transmit one of different control signals, which corresponds to said one of the predetermined directions, through said communication module to the portable wireless communication device so as to control the portable wireless communication device to execute a corresponding operation.

6. A wireless communication system comprising:
a portable wireless communication device; and
a remote control device including
a communication module operable to wirelessly communicate with said portable wireless communication device,
a detecting module configured to detect a movement direction of an object within a predetermined space, and
a control unit electrically coupled to said detecting module and said communication module, and operable to determine whether the object moves in a predetermined direction according to detection result from said detecting module, and to transmit through said communication module a control signal to said portable wireless communication device so as to control operation of said portable wireless communication device when it is determined that the movement of the object detected by said detecting module is in the predetermined direction.

7. The wireless communication system as claimed in claim 6, wherein said portable wireless communication device is a cellular phone, and the operation thereof is one of answering an incoming telephone call and terminating a telephone call.

8. The wireless communication system as claimed in claim 6, wherein said detecting module of said remote control device is an infrared detecting module.

9. The wireless communication system as claimed in claim 6, wherein said communication module of said remote control device is a Bluetooth module.

10. The wireless communication system as claimed in claim 6, wherein, when it is determined that the movement of the object detected by said detecting module is in one of predetermined directions, said control unit is operable to transmit one of different control signals, which corresponds to said one of the predetermined directions, through said communication module to said portable wireless communication device so as to control said portable wireless communication device to execute a corresponding operation.
